(19) United States
(12) Patent Application Publication
(10) Pub. No.: US 2013/0186268 A1
(43) Pub. Date: Jul. 25, 2013

(54) DEHYDRATION UNIT

(71) Applicant: David K. Hill, Oklahoma City, OK (US)

(72) Inventor: David K. Hill, Oklahoma City, OK (US)

(73) Assignee: KIMRAY, INC., Oklahoma City, OK (US)

(21) Appl. No.: 13/878,343

(22) PCT Filed: Oct. 12, 2011
(86) PCT No.: PCT/US11/55933

§ 371 Date: Apr. 8, 2013

Related U.S. Application Data
(60) Provisional application No. 61/392,337, filed on Oct. 12, 2010.

(51) Int. Cl. B01D 53/26

(52) U.S. Cl. CPC B01D 53/263
USPC 95/10; 96/242

(57) ABSTRACT

This disclosure describes an automatic adjusting natural gas dehydration system. The dehydration system includes a still column, a reboiler, a pump and an absorber column suitable for circulating a desiccant, The absorber column includes inlet and outlet ports for receiving a stream of natural gas. The method automatically adjusts the flow rate the desiccant and the temperature of the desiccant within the reboiler in response to the moisture content of the natural gas exiting the absorber column after contacting the desiccant.

### BACKGROUND

This application claims priority to U.S. Provisional Application Ser. No. 61/392337, filed Oct. 12, 2011, incorporated herein by reference.

Natural gas dehydration systems are commonly used to remove water from natural gas. The systems are designed to lower the water content of natural gas such that the gas is suitable for commercial sale and usage. The gas in most cases must, at a minimum, meet pipeline quality specifications, which generally provide that water content shall not exceed 7 lb/MMSCF (seven pounds per million standard cubic feet). Such systems are commonly used at oil and gas well sites.

One known type of dehydration unit uses glycol as a desiccant to remove water from natural gas. Glycols typically used are triethylene glycol, diethylene glycol, ethylene glycol, and tetra ethylene glycol. The typical process may generally be described as follows.

Glycol is fed to the top of an absorber, which may also be referred to as a contactor. Wet gas enters the absorber, and passes upwardly therein. The glycol contacts the wet gas in the absorber and dry gas exits the absorber at, or near the top of the absorber. The dry gas that leaves the absorber may be communicated to a pipeline system, gas plant or other desired location. The dry gas must be below a specified water content, for example, 7 lb/mmsfd.

The glycol, after it removes water from natural gas exits the absorber and is treated to remove water, and to regain high purity glycol that can be once again circulated through the absorber to remove water from natural gas. Natural gas dehydration systems may include a filter at the exit of the absorber to clean impurities from the glycol. The glycol after it leaves the absorber is heated in a reboiler to remove the water therefrom. The reboiler may have a still column through which the glycol enters, and in which the glycol is heated and water vapors are removed. As the glycol exits the reboiler, it may pass through a carbon filter designed to remove other hydrocarbon impurities. The cleaned, or purified glycol is then pumped into the absorber. The glycol may pass through a cross heat exchanger prior to entering the absorber. In the heat exchanger, the glycol leaving the reboiler is cooled by glycol leaving the absorber and the glycol leaving the absorber is heated by the glycol leaving the reboiler.

In operation, certain parameter ranges are known. For example, the type of desiccant is known. The ranges of water content of the natural gas coming into the absorber and the desired water content for the exiting natural gas are also known. The reboiler temperature, along with glycol circulation rate can be set based on the known ranges of the water content of incoming natural gas and desired water content of exiting natural gas.

The water content of the gas is measured and monitored to ensure the natural gas meets specifications. Assuming a static environment, with no changes to any parameters, the current natural gas dehydration systems operate adequately. However changes inevitably occur such as saturation conditions, temperatures, pressures, natural gas flow rates, or degradation of the efficiency of the dehydration equipment and at times the water content of the natural gas exiting the absorber reaches an unacceptable level. Typically, when the water content begins to approach an unacceptable level, changes must be made to the operating parameters of the system. The two variables most often changed to impact water content are glycol circulation rate and reboiler temperature. The current method for manipulating these parameters requires sending an operator to the site of the natural gas dehydrator, which may be for example an oil and gas well site, so that the operator can manually change the glycol circulation rate and/or the reboiler temperature. The most common change is a change to be glycol circulation rate. In other words, when unacceptable water content is approached, an operator will travel to the site, and will manually manipulate a valve, or pump to change the rate of the glycol circulation through the absorber. At times, the increased glycol circulation rate will not remedy the problem, and an operator may return to the site to increase or decrease reboiler temperature, depending on which way the water content need to be moved. Most often, the water content approaches an unacceptably high level, which may be remedied by an increase in glycol circulation rate, and/ or increase in reboiler temperature. With known natural gas dehydration systems at oil and gas well sites, any changes, whether made to decrease or increase water content, must be made manually which requires an operator be present at the site or to travel to the site.

### SUMMARY

In one embodiment, the present invention provides an automated system for controlling the dehydration of natural gas, i.e. removing moisture from natural gas. The automated system includes a reboiler in fluid communication with a pump; an absorber in fluid communication with the pump, the absorber having a natural gas inlet and a natural gas outlet; a liquid desiccant; and, a still column in fluid communication with the absorber and the reboiler, whereby the reboiler, the still and the absorber form a fluid circulation loop for use and regeneration of the desiccant. Additionally, the automated system includes a flow transmitter; a circulation controller; a temperature transmitter associated with the reboiler to monitor and report reboiler fluid temperature; a first moisture transmitter in fluid communication with the natural gas inlet, the first moisture transmitter is positioned to determine moisture content of natural gas entering the natural gas inlet; a second moisture transmitter in fluid communication with the natural gas outlet, the second moisture transmitter positioned to determine moisture content of natural gas exiting through the natural gas outlet; a burner positioned to heat the reboiler; a burner controller suitable for controlling operation of the burner; and, the circulation controller, configured to direct operation of the burner controller and the pump, wherein the circulation controller receives data from the first and second moisture transmitters, the temperature transmitter and the flow transmitter.

In another embodiment, the present invention provides a method for automatically controlling the dehydration of natural gas. The method of the current invention includes the steps of directing natural gas through an absorber column; directing a desiccant fluid through said absorber column; contacting said natural gas with said desiccant fluid within said absorber column thereby reducing the moisture content of said natural gas; following contact of said desiccant fluid with said natural gas, directing said desiccant fluid from said absorber to a still column and then to a reboiler followed by returning said desiccant fluid to said absorber column; continuously monitoring the conditions of the circulation rate of said desiccant fluid, the moisture content of said natural gas entering and exiting said absorber column and the temperature of said desiccant in said reboiler; and, in response to changes in said monitored conditions of desiccant circulation rate, desiccant temperature and natural gas moisture content, adjusting the circulation rate of said dessicant fluid through said still column, said reboiler and said absorber and/or adjusting the temperature of said dessicant fluid in said reboiler.

### BRIEF DESCRIPTION OF THE DRAWINGS

FIG. 1 schematically depicts one embodiment of the present invention.

FIG. 2 is an example of a control logic flow chart suitable use by the circulation controller 31 in the method of the current invention.

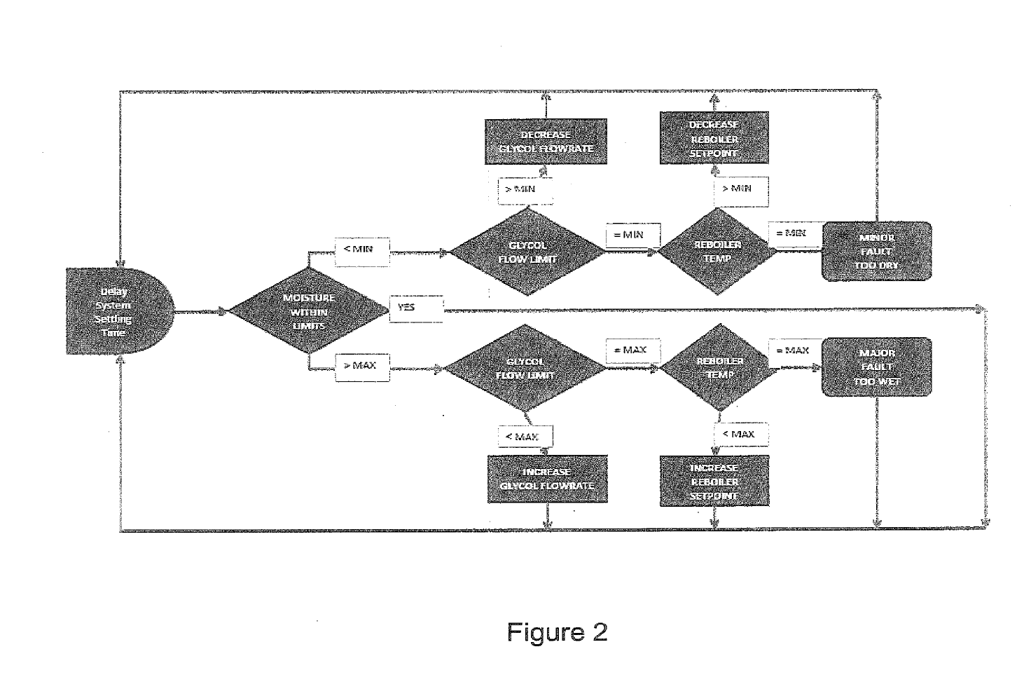

### DETAILED DESCRIPTION

The current application discloses an automated natural gas dehydrating system in which parameters are monitored and data is sent to a programmable controller which will automatically adjust the parameters of the system to maintain the desired water content of the gas exiting the absorber.

The system described herein will automatically control the natural gas dehydration process. The automated natural gas dehydration system will provide for monitoring and adjustment of applicable variables and parameters to accommodate for changes in process conditions that affect the moisture content of the natural gas discharged from the absorber. The system will communicate the condition of the variables and other important system variables remotely so that monitoring can occur off site. The monitored variables may include: glycol circulation rate, reboiler temperature and moisture content of the inlet and outlet natural gas conditions from the absorber. Other miscellaneous variables such as gas temperature, absorber, inlet and outlet pressure, and gas flow rate may be monitored and communicated to provide information on system status. Thus, sensors such as temperature sensors or transmitters may be associated with individual components including but not limited to reboiler 20.

The natural gas dehydration system described herein monitors the moisture content of the natural gas at the inlet and outlet to the absorber. If the moisture content at the outlet is not as desired, the circulation rate of the glycol and/or reboiler temperature are automatically adjusted to effect the desired changes to the moisture content of the natural gas at the outlet of the absorber. Typically, increases in the glycol circulation rate decreases the moisture content, and an increase in reboiler temperature will result in higher purity glycol, which will also decrease in the moisture content at the outlet.

The operation of a gas dehydration system for controlling the moisture content of natural gas, and for automatically adjusting parameters of the system may be generally described as follows.

The natural gas dehydration system 10 includes a reboiler 20 and a pump 30 driven by a motor 40. Reboiler 10 has an outlet 50 through which heated glycol, or other desiccant passes into pump 30. Glycol is pumped into an absorber 60 at a glycol inlet 70, and passes out of absorber 60 through glycol outlet 80. Absorber 60 has a natural gas inlet 90, and a natural gas outlet 100, which will deliver gas to a pipe line or other desired location. Water laden glycol is delivered into a still column 110 at the top of reboiler 20, and passes into reboiler 20 therefrom. Other filters and scrubbers may be used. For example, an inlet scrubber may be used to remove liquid hydrocarbons, salts and other impurities at the natural gas inlet 90. A filter may likewise be placed between glycol outlet 80 and still column 110. A cross heat exchanger can be utilized to cool the pure glycol before it enters the absorber 60, and to heat the water rich glycol that leaves the absorber 60.

The system 10 operates as follows. Certain parameters will be known, or set. For example, the moisture content at the gas inlet 90, and the desired moisture content at the natural gas outlet 100 are known. The type of desiccant is known, maximum and minimum reboiler tamperatures are known, and such parameters are entered into a circulation controller 31 at the time of setup. Other parameters, such as inlet and outlet absorber pressure are known.

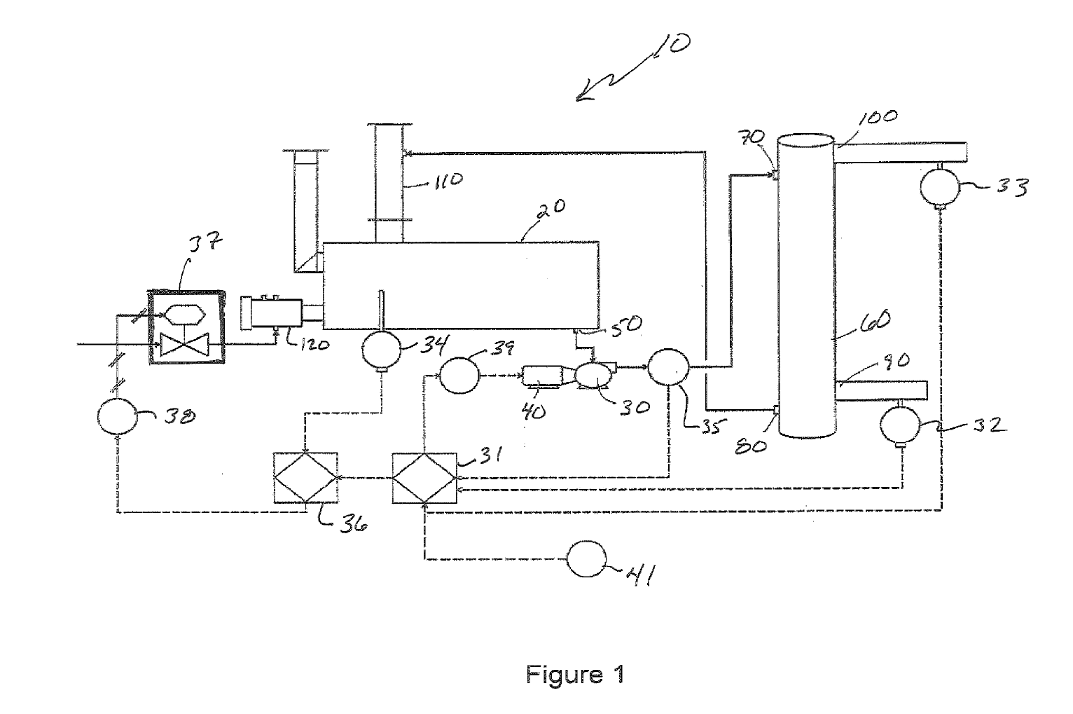

As seen in FIG. 1, the moisture content at the natural gas inlet 90 is obtained by a moisture transmitter 32. The moisture content at gas outlet 100 is obtained by a second moisture transmitter 33. The temperature conditions of reboiler 20 are obtained by a temperature transmitter 34, and glycol circulation rates are obtained by a flow transmitter 35.

The reboiler temperatures are controlled separately by a burner controller 36. The reboiler temperature set point, which is between the minimum and maximum may be adjusted remotely by burner controller 36, based on input from the circulation controller 31. The burner controller 36 maintains the reboiler temperature by adjusting output electronically to a burner control valve 37 that throttles the fuel gas to the burner 120. In this case, the output from 36 is converted to a pneumatic signal by a transducer 38 to modulate pneumatic temperature control valve 37.

The circulation controller 31 is programmed to automatically adjust the outputs to the burner controller 36 and the variable frequency drive 39 to control reboiler temperature set point and glycol circulation rates.

During operation the natural gas moisture content at the outlet is monitored by the inlet moisture transmitter 32 and outlet moisture transmitter 33 both of which deliver inputs to the circulation controller 31. The current glycol circulation rates are transmitted to the circulation controller 31 by the flow transmitter 35. The circulation controller 31 evaluates the inlet and outlet conditions of the natural gas, current circulation rates and reboiler temperature set points and then sends outputs to the variable frequency drive 39 of the electric pump motor 40 which in turn increases or decreases the circulation rates to affect the natural gas outlet moisture conditions accordingly. Additionally, the circulation controller 31 sends an output to the burner controller 36 to increase or decrease the set point of the reboiler to further affect the outlet moisture conditions. All the outputs from the circulation controller 31 are based on the process control logic programmed into the circulation controller 31.

Miscellaneous inputs 41 such as gas temperature, pressure and flow may be monitored through the system as desired by the end user to remotely communicate the system status.

Assuming a moisture content at 33 that begins to exceed the predetermined upper control limit for moisture content, the circulation controller 31 begins to increase the circulation rate of pump 30 by sending an output signal to 39. Circulation rates increase and the outlet moisture condition 33 is monitored to determine if moisture content decreases below the predetermined upper control limit. This process is incrementally repeated until the moisture control of natural gas outlet 100 is brought back within control limits, at which time those current settings are maintained. However, if after a period of time glycol circulation control is not adequate to bring the moisture content to a desired level, a signal is sent by controller 31 to the burner controller 36 to increase the reboiler temperature. This process is incrementally repeated until the moisture content at the natural gas outlet 100 is brought back within control limits upon which time the current settings are maintained. If the desired moisture content cannot be met, then an alarm is sent.

Assuming an outlet moisture condition at 33 that is below the predetermined lower control limit for moisture content, the circulation controller 31 sends a signal to the burner controller 36 to decrease the reboiler temperature set point. This process is incrementally repeated down to the predetermined minimum burner temperature set point. If after a period of time the moisture content of the natural gas outlet is brought back up within the control limit then no further adjustments are made. However, if after a period of time the moisture control at the natural gas outlet 100 continues to be below the lower control limit, a signal is sent to the variable frequency drive 39 to reduce the circulation rate. This process is incrementally repeated until the moisture content at the outlet is brought back above the lower control limits upon which time the current settings are maintained. If the outlet moisture content at the natural gas outlet is below the predetermined lower control limit, then system 10 will operate at the predetermined minimum set points for glycol circulation and reboiler temperature.

Thus, system 10 is a fully automated system designed to monitor moisture content of natural gas leaving an absorber, and to automatically adjust certain parameters if the moisture content nears, or reaches an upper or lower control limit. In the described embodiment, glycol circulation rate and reboiler temperature are automatically adjusted, but other parameters, such as pressure drops across filters, still column temperatures, heat exchange discharge temperatures may be monitored and adjusted as well. By remotely monitoring system conditions, transmitting system conditions to a controller and automatically adjusting parameters to maintain a moisture content between upper and lower control limits, natural gas is dehydrated more efficiently. The need to send operators to the system 10 at a well site is eliminated, the system 10 uses only that amount of energy and desiccant necessary, and moisture content is consistently maintained so that shut downs of the system, which are costly, may be avoided.

I claim:

1. A system for automatically controlling the dehydration of natural gas comprising;
a reboiler in fluid communication with a pump;
an absorber in fluid communication with said pump, said absorber having a natural gas inlet and a natural gas outlet;
a liquid desiccant; and,
a still column in fluid communication with said absorber and said reboiler, whereby said reboiler, said still and said absorber form a fluid circulation loop for use and regeneration of said desiccant.

2. The system of claim 1, further comprising a heat exchanger positioned between said pump and said absorber, said heat exchanger having a first line providing fluid communication with said pump and said absorber.

3. The system of claim 1, wherein said heat exchanger has a second line in fluid communication with said absorber and said still column.

4. The system of claim 1, further comprising a first moisture content analyzer in fluid communication with said natural gas inlet and said first moisture content analyzer is positioned in the flow path of natural gas entering said natural gas inlet.

5. The system of claim 1, further comprising a second moisture content analyzer in fluid communication with said natural gas outlet and said second moisture content analyzer is positioned in the flow path of natural gas exiting through said natural gas outlet.

6. The system of claim 1, further comprising a temperature transmitter positioned to monitor the temperature of fluid within said reboiler.

7. The system of claim 1, further comprising a flow transmitter positioned to monitor fluid flow rate between said pump and said absorber.

8. The system of claim 1, further comprising:
a flow transmitter;
a circulation controller;
a temperature transmitter associated with said reboiler to monitor and report reboiler fluid temperature;
a first moisture transmitter in fluid communication with said natural gas inlet, said first moisture transmitter is positioned to determine moisture content of natural gas entering said natural gas inlet;
a second moisture transmitter in fluid communication with said natural gas outlet, said second moisture transmitter positioned to determine moisture content of natural gas exiting through said natural gas outlet;
a burner positioned to heat said reboiler;
a burner controller suitable for controlling operation of said burner; and,
said circulation controller, configured to direct operation of said burner controller and said pump, wherein said circulation controller receives data from said first and second moisture transmitters, said temperature transmitter and said flow transmitter.

9. A method for automatically controlling the operation of a natural gas dehydration unit comprising the steps:
directing natural gas through an absorber column;
directing a desiccant fluid through said absorber column;
contacting said natural gas with said desiccant fluid within said absorber column thereby reducing the moisture content of said natural gas;
following contact of said desiccant fluid with said natural gas, directing said desiccant fluid from said absorber to a still column and then to a reboiler followed by returning said desiccant fluid to said absorber column;
continuously monitoring the conditions of the circulation rate of said desiccant fluid, the moisture content of said natural gas entering and exiting said absorber column and the temperature of said desiccant in said reboiler; and,
in response to changes in said monitored conditions of desiccant circulation rate, desiccant temperature and natural gas moisture content, adjusting the circulation rate of said desiccant fluid through said still column, said reboiler and said absorber and/or adjusting the temperature of said desiccant fluid in said reboiler.

10. The method of claim 9, wherein in response to changes in said monitored conditions of desiccant circulation rate, desiccant temperature and natural gas moisture content, if said moisture content of said natural gas exiting said absorber column is greater than desired, adjusting the circulation rate of said desiccant will increase said circulation rate.

11. The method of claim 9, wherein in response to changes in said monitored conditions of desiccant circulation rate, desiccant temperature and natural gas moisture content, if said moisture content of said natural gas exiting said absorber column is greater than desired, adjusting the temperature of said desiccant in said reboiler will increase the temperature of said desiccant in said reboiler.

12. The method of claim 9, wherein in response to changes in said monitored conditions of desiccant circulation rate, desiccant temperature and natural gas moisture content, if said moisture content of said natural gas exiting said absorber column is less than desired, adjusting the circulation rate of said desiccant will decrease said circulation rate.

13. The method of claim 9, wherein in response to changes in said monitored conditions of desiccant circulation rate, desiccant temperature and natural gas moisture content, if said moisture content of said natural gas exiting said absorber column is less than desired, adjusting the temperature of said desiccant in said reboiler will decrease the temperature of said desiccant in said reboiler.

14. The method of claim 9, wherein in response to changes in said monitored conditions of desiccant circulation rate, desiccant temperature and natural gas moisture content, if said moisture content of said natural gas exiting said absorber column is greater than desired, increasing both the circulation rate of said desiccant and the temperature of the desiccant in said reboiler.

15. The method of claim 9, wherein in response to changes in said monitored conditions of desiccant circulation rate, desiccant temperature and natural gas moisture content, if said moisture content of said natural gas exiting said absorber column is less than desired, decreasing both the circulation rate of said desiccant and the temperature of the desiccant in said reboiler.
